(19) United States
(12) Patent Application Publication
(10) Pub. No.: US 2025/0110894 A1
(43) Pub. Date: Apr. 3, 2025

(54) Scratchpad Memory Translation Lookaside Buffer

(71) Applicant: Advanced Micro Devices, Inc., Santa Clara, CA (US)

(72) Inventor: Mark Evan Wilkening, Cambridge, MA (US)

(73) Assignee: Advanced Micro Devices, Inc., Santa Clara, CA (US)

(21) Appl. No.: 18/476,636

(22) Filed: Sep. 28, 2023

(51) Int. Cl. G06F 12/1045

(52) U.S. Cl. CPC G06F 12/1045; G06F 2212/1016

(57) ABSTRACT

Scratchpad memory translation lookaside buffer techniques are described. In an implementation, the techniques described herein relate to a device including a memory management unit implemented in hardware of an integrated circuit to receive a mapping instruction from a mapping instruction source, the mapping instruction specifying a mapping between a virtual memory address and a physical memory address of a scratchpad memory and store a virtual-to-physical mapping entry in a translation lookaside buffer based on the mapping instruction.

### BACKGROUND

Data access efficiency by a processing device from memory is a major factor on overall usable speed by the processing device to execute operations. Accordingly, techniques and devices have been developed to increase data access efficiency from memory. However, conventional techniques to do so encounter technical challenges resulting from inefficiencies in managing how this access is implemented. An example of which includes techniques used by conventional cache systems to internally manage data access to respective cache levels. Consequently, conventional cache systems do not support an ability to track how the data access is managed nor control this access outside of the conventional cache systems.

### BRIEF DESCRIPTION OF THE DRAWINGS

The detailed description is described with reference to the accompanying figures.

FIG. 1 is a block diagram of a non-limiting example system configured to implement scratch memory translation lookaside buffer techniques.

FIG. 2 is a block diagram of a non-limiting example system configured to set address mappings in an instruction managed translation lookaside buffer based on a mapping instruction received from a processing core of a processing device.

FIG. 3 is a block diagram of a non-limiting example system configured to employ address mappings in an instruction managed translation lookaside buffer of FIG. 2 to implement a memory instruction to a scratchpad memory that is received from a processing core of a processing device.

FIG. 4 is a block diagram of a non-limiting example system showing operation of an instruction managed translation lookaside buffer and scratchpad memory in greater detail in conjunction with additional data management memory functionality of a processing device.

FIG. 5 is a flow diagram depicting a step-by-step procedure in an example implementation of operations performable in hardware and software as described herein for accomplishing a result of setting a virtual-to-physical mapping entry in an instruction based translation lookaside buffer by execution of a mapping instruction source and translation of a virtual memory address of a memory instruction issued by a memory instruction source to access a physical memory address of a scratchpad memory.

### DETAILED DESCRIPTION

### Overview

Data access efficiency by a processing device to memory is a major factor on the overall speed usable by the processing device to execute operations. To increase this efficiency, techniques have been developed to “move data closer” for access by a processing core of the processing device. For a general purpose central processing unit (CPU), for instance, cache systems are employed to store data in cache levels on an integrated circuit that is also used to implement processing cores of the processing device that are used to process the data. In this way, cache systems reduce an amount of latency in accessing data by the processing cores “on chip” (e.g., using static random access memory) of an integrated circuit as compared with accesses to data “off chip,” e.g., to volatile main memory implemented using dynamic random access memory.

However, conventional techniques used to manage what items of data are maintained by the cache systems are managed internally and do not support outside control. Conventional cache systems, for instance, rely on temporal and spatial locality. Spatial locality is used to improve operation in situations in which data is requested that is stored physically close to data that is a subject of a previous request. Temporal locality is used to address scenarios in which data that has already been requested will be requested again. Each of these instances in conventional techniques, however, is managed internally by the cache system and does not support outside control. Consequently, conventional techniques face numerous technical challenges in tracking data accesses and managing what otherwise appears to the cache system as seemingly randomly accessed data, i.e., access to memory by the processing device does not have a discernable pattern to the cache system.

Scratchpad memory has been developed as a mechanism to address these challenges. However, convention techniques used to implement scratchpad memory are limited to use in particular scenarios. Scratchpad memory is a type of memory that is maintained in hardware of physical memory, e.g., “on chip” as static random access memory (SRAM) as part of an integrated circuit that also implements the processing device 104. The scratchpad memory utilizes physical memory addresses as part of a physical scratchpad address space, e.g., similar to volatile main memory. The scratchpad memory is configured to maintain data involved in execution of an operating system, application, or other memory instruction source. For example, scratchpad memory is deterministic in that allocation and deallocation of memory and subsequent storing and/or loading of data is determined through execution of software by a processing device. As a result, operation of the scratchpad memory is directly controllable through execution of the operating system, application, and so forth.

Conventional uses of scratchpad memory, however, are limited in real world scenarios to specialized systems, graphics processing units, and domain-specific accelerators. Consequently, conventional scratchpad memory is incapable of implementation in general purpose scenarios, such as for use in general purpose central processing unit (CPU) workloads. This is because conventional scratchpad memory techniques do not support shared memory coherence or memory virtualization and are thus “inflexible” in operation when confronted with use in general purpose scenarios.

To address these problems and technical challenges, a translation lookaside buffer is employed “on chip” in memory of the processing device (e.g., as included in SRAM) to aid operation and overcome conventional limitations of scratchpad memory and cache systems. To do so, the translation lookaside buffer is managed using mapping instructions issued by a mapping instruction source to control which address mappings are maintained in the buffer, e.g., as virtual-to-physical mapping entries. Thus, in the following discussion the translation lookaside buffer employed by the scratchpad memory is also referred to as an “instruction managed TLB.”

The virtual-to-physical mapping entries, for instance, are used to map virtual memory addresses as utilized as part of software execution (e.g., operating system and applications) by processing cores of a processing device to physical memory addresses employed by the scratchpad memory. Accordingly, a subsequent memory instruction received due to execution of software by a processing core (e.g., a load or store instruction) that specifies a virtual memory address is translated by a virtual-to-physical mapping entry in the instruction based TLB to a physical memory address of the scratchpad memory. As a result, data maintained at the physical memory addresses of the scratchpad memory is accessible using the memory instruction based on a translation performed by the instruction managed TLB. The translation is based on virtual-to-physical mapping entries maintained in the instruction managed TLB responsive to mapping instructions received through execution of the software of the processing core. Accordingly, the software is given control in this example both over what entries are maintained in the instruction managed TLB and in the scratchpad memory.

The instruction managed TLB and corresponding scratchpad memory are configurable to support context switches and virtualization of scratchpad mappings across processes. To do so in one or more examples, a backing store is implemented in volatile main memory, e.g., DRAM. The backing store is configured to maintain translation tables and corresponding virtual-to-physical mappings used by the instruction managed TLB for each of the processes executed by the processing core. The translation tables (and corresponding virtual-to-physical mappings) are then switched in the instruction managed TLB for use by respective processes executed by the processing core. The backing store, for instance, is managed by an operating system to store translation tables to enable a context switch between processes in order to also switch translation tables and corresponding virtual-to-physical mappings corresponding to the processes between storage in volatile main memory as part of the backing store (e.g., DRAM) that is “off-chip” and “on-chip” memory of the instruction managed TLB, e.g., using SRAM.

In this way, the instruction managed TLB in conjunction with the scratchpad memory supports use in general purpose scenarios, such as for use in processing general purpose CPU workloads which is not possible in conventional techniques. A variety of other instances are also contemplated, examples of which are described in the following discussion and shown using corresponding figures.

In some aspects, the techniques described herein relate to a device including a memory management unit to receive a mapping instruction from a mapping instruction source, the mapping instruction specifying a mapping between a virtual memory address and a physical memory address of a scratchpad memory, and store a virtual-to-physical mapping entry in a translation lookaside buffer based on the mapping instruction.

In some aspects, the techniques described herein relate to a device, wherein the mapping instruction specifies a range of said virtual memory addresses that are to be mapped to a respective range of physical memory addresses of the scratchpad memory.

In some aspects, the techniques described herein relate to a device, wherein the mapping instruction specifies a coherence behavior to manage data consistency at the physical memory address of the scratchpad memory.

In some aspects, the techniques described herein relate to a device, further including a processing core configured to execute the mapping instruction source to generate the mapping instruction to map the virtual memory address to the physical memory address of the scratchpad memory.

In some aspects, the techniques described herein relate to a device, wherein the processing core, the translation lookaside buffer, the scratchpad memory, and the memory management unit are implemented in hardware of an integrated circuit.

In some aspects, the techniques described herein relate to a device, wherein the mapping instruction source is an operating system or application executed by the processing core, the operating system or application employs the virtual memory address, and the processing core is configured as a central processing unit.

In some aspects, the techniques described herein relate to a device, further including a backing store maintained in volatile main memory, the backing store configured to maintain mappings between virtual memory addresses and physical memory addresses of the scratchpad memory.

In some aspects, the techniques described herein relate to a device, wherein the backing store supports context switches of a process executed by a respective processing core.

In some aspects, the techniques described herein relate to a device, wherein the backing store supports virtualization of the mapping across processes executed by respective processing cores of a plurality of processing cores.

In some aspects, the techniques described herein relate to a device, further including a static random access memory implementing the scratchpad memory to store data at the physical memory address.

In some aspects, the techniques described herein relate to a system including a processing core configured to generate a memory instruction to a scratchpad memory, the memory instruction specifying a virtual memory address, and a memory management unit implemented to map the virtual memory address to a physical memory address of the scratchpad memory using a translation lookaside buffer, and transmit the memory instruction to the physical memory address of the scratchpad memory to execute the memory instruction.

In some aspects, the techniques described herein relate to a system, wherein the memory instruction is a load instruction to load data from the physical memory address of the scratchpad memory to the processing core, or a store instruction to store data from the processing core to the physical memory address of the scratchpad memory.

In some aspects, the techniques described herein relate to a system, wherein the processing core is configured to generate a mapping instruction specifying a mapping between the virtual memory address and the physical memory address of the scratchpad memory, and the memory management unit is configured to store a virtual-to-physical mapping entry in the translation lookaside buffer based on the mapping instruction.

In some aspects, the techniques described herein relate to a system, further including a backing store maintained in physical memory, the backing store configured to maintain mappings between virtual memory addresses and physical memory addresses of the scratchpad memory.

In some aspects, the techniques described herein relate to a system, wherein the backing store supports context switches of a process executed by a respective processing core.

In some aspects, the techniques described herein relate to a system, wherein the backing store supports virtualization of the mapping across processes executed by respective processing cores of a plurality of processing cores.

In some aspects, the techniques described herein relate to a system, further including a physical memory implementing the scratchpad memory using dynamic random access memory to store data at the physical memory address.

In some aspects, the techniques described herein relate to a method including receiving a mapping instruction at a memory management unit, the mapping instruction specifying a mapping of a virtual memory address to a physical memory address of a scratchpad memory, storing a virtual-to-physical mapping entry in a translation lookaside buffer based on the mapping instruction, and controlling access, by the memory management unit, of a memory instruction to the physical memory address of the scratchpad memory by translating the virtual memory address received via the memory instruction to the physical memory address of the scratchpad memory based on the stored virtual-to-physical mapping entry in the translation lookaside buffer.

In some aspects, the techniques described herein relate to a method, wherein the mapping instruction specifies a range of said virtual memory addresses that are to be mapped to a respective range of physical memory addresses of the scratchpad memory.

In some aspects, the techniques described herein relate to a method, wherein the mapping instruction specifies a coherence behavior to manage data consistency at the physical memory address of the scratchpad memory.

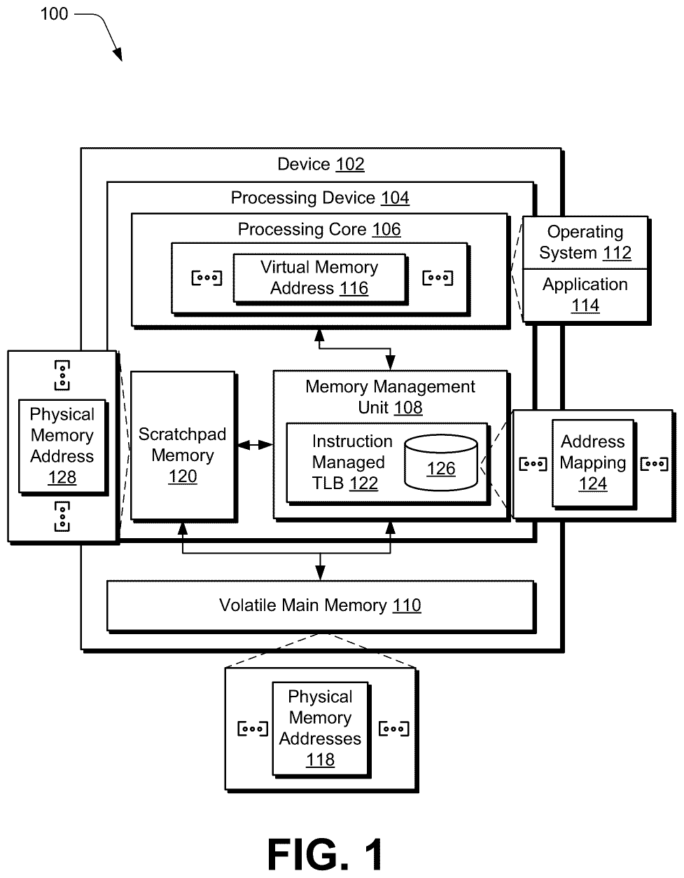

FIG. 1 is a block diagram of a non-limiting example system 100 configured to implement scratch memory translation lookaside buffer techniques. The system 100 includes a device 102 having a processing device 104. The processing device 104 includes one or more processing cores (illustrated as processing core 106) and a memory management unit 108. The device 102 also includes a volatile main memory 110 that is communicatively coupled to the processing device 104, e.g., via a bus or other communication structure.

The device 102 is configurable in a variety of ways. Examples of device 102 configurations include, by way of example and not limitation, computing devices, servers, mobile devices (e.g., wearables, mobile phones, tablets, laptops), processors (e.g., graphics processing units, central processing units, and accelerators), digital signal processors, interference accelerators, disk array controllers, hard disk drive host adapters, memory cards, solid-state drives, wireless communications hardware connections, Ethernet hardware connections, switches, bridges, network interface controllers, and other apparatus configurations. Additional examples include artificial intelligence training accelerators, cryptography and compression accelerators, network packet processors, and video coders and decoders.

The processing device 104 is configurable in hardware as one or more integrated circuits, e.g., as implemented using circuits as part an integrated circuit package in hardware. The processing device 104, for instance, is configurable as a central processing unit having a processing architecture that is fabricated using a semiconductor manufacturing process, e.g., using silicon wafers. The processing device 104 is configurable within a motherboard of the device 102 as communicatively coupled with other components, e.g., the volatile main memory 110 via a system bus.

One or more processing cores are included as part of the processing device 104, an illustrated example of which includes processing core 106. The processing core 106 is a unit within the processing device 104 (e.g., a CPU) implemented in hardware using an integrated circuit that is used to read and execute instructions, e.g., independently of other cores included on the processing device 104. The processing core 106, for instance, is configured to execute instructions included as part of an operating system 112, application 114, or other software to perform corresponding operations.

The volatile main memory 110 is implemented in hardware, e.g., as one or more memory modules implemented on a printed circuit board that is physically and communicatively connectable to a motherboard of the device 102. The volatile main memory 110, for instance, is communicatively coupled via a system bus of the device 102 to the processing device 104 implementing the processing core 106. The volatile main memory 110 is configurable in a variety of ways, examples of which include dynamic random access memory.

The memory management unit 108 is implemented in hardware of the processing device 104 (e.g., as an integrated circuit) to manage memory and caching operations associated between the processing core 106 and the volatile main memory 110. The memory management unit 108, for instance, is tasked with management of virtual memory addresses 116 employed through the execution of software by the processing core 106 with respect to physical memory addresses 118 utilized by the volatile main memory 110.

Virtual memory is a technique used to expand functionality made available by devices to manage data storage. To support this, the memory management unit 108 is tasked with translation between the virtual memory addresses 116 and the physical memory addresses 118, e.g., between an operating system 112 executed on the processing core 106 with physical memory addresses 118 in volatile main memory 110. The memory management unit 108 divides a virtual address space into page tables and page table entries as part of a multilevel page table hierarchy. This technique is performed to reduce an amount of memory used to implement translation by the memory management unit 108.

The processing device 104 in the illustrated example further includes a scratchpad memory 120, e.g., implemented as a static random access memory (SRAM). The scratchpad memory 120 is an instruction managed memory that is employed “on chip” (i.e., as part of the processing device 104) to store data, temporarily, during the execution of software by the processing core 106. The scratchpad memory 120, for instance, is configurable as part of random access memory (e.g., SRAM) that is accessible by the processing core 106 by bypassing a cache system. The scratchpad memory 120 is deterministic, in that, data that is maintained within the scratchpad memory 120 is controlled through execution of the software by the processing core 106, e.g., the operating system 112 and/or the application 114.

As previously described, conventional scratchpad memory configurations do not support operation in conjunction with general-purpose CPU workloads. To overcome this technical challenge, hardware support is implemented in the illustrated example through use of an instruction managed translation lookaside buffer (TLB), which is depicted as instruction managed TLB 122.

The instruction managed TLB 122 is implemented in “on chip” memory includes address mappings 124 that are maintained in storage 126, e.g., hardware implemented memory such as a static random access memory as part of the processing device 104. The address mappings 124 are configured to map the virtual memory addresses 116 as used by software executed by the processing core 106 with physical memory addresses 128 of the scratchpad memory 120. The instruction managed TLB 122, therefore, supports address mapping 124 as specified by the software executed by the processing core 106 between a physical scratchpad address space utilized by the scratchpad memory 120 and a virtual address space used by the software, e.g., the operating system 112 and/or application 114.

As a result, execution of software by the processing core 106 is provided with an ability to dynamically map shared coherent virtual memory explicitly to fast local storage arrays “on chip” of the scratchpad memory 120 through use of the instruction managed TLB 122. Software that supports intelligent data management, for instance, is configurable to make use of software pipelining and tiling to reduce memory-access latency through explicit and deterministic data prefetching using the instruction managed TLB 122 and scratchpad memory 120.

Use of the address mapping 124 and instruction managed TLB 122 also support an ability to explicitly isolate data, e.g., prioritized reuse data from streamed non-temporal data through use of respective address mappings 124. The instruction managed TLB 122 further supports use of multi-level hierarchies to implicitly swizzle data, e.g., to increase vectorization efficiency. To “swizzle” data, data object references are converted from one form to another, e.g., to move an object to different areas of memory by replacing persisted identifiers (e.g., disk offsets) that are no longer applicable due to movement of the data object with memory addresses.

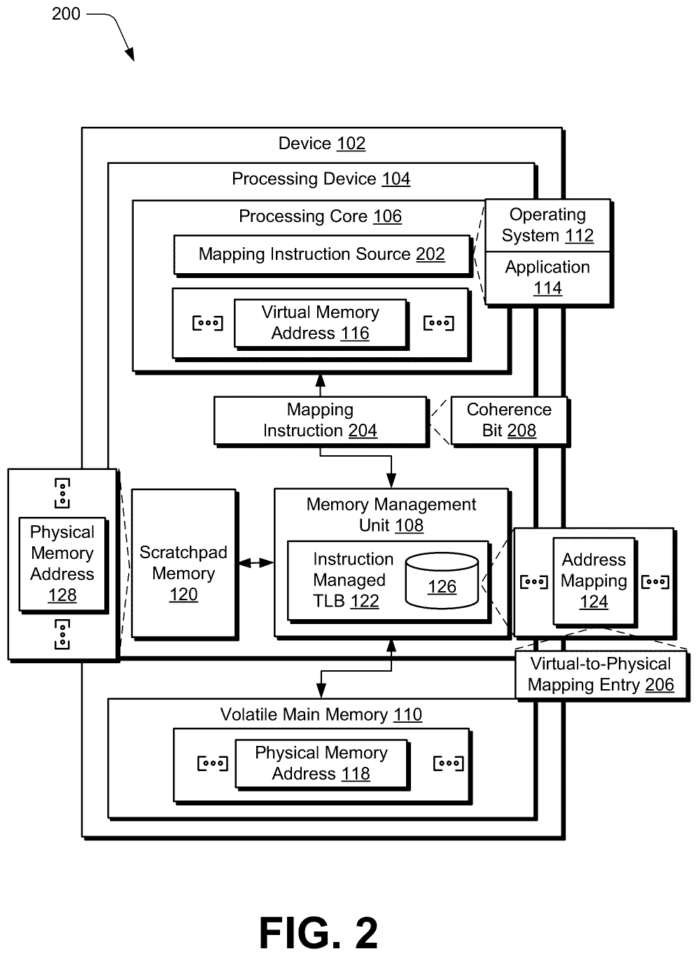

FIG. 2 is a block diagram of a non-limiting example system 200 configured to set address mappings in an instruction managed translation lookaside buffer based on a mapping instruction received from a processing core of a processing device. The processing core 106 is illustrated as including a mapping instruction source 202. The mapping instruction source 202 is implemented through execution of software (e.g., operating system 112 and/or application 114) having instructions that are executable by the processing core 106 to perform operations.

The mapping instruction source 202 is configured to generate a mapping instruction 204 that is usable to control address mappings 124 between the virtual memory addresses 116 and the physical memory addresses 128 of the scratchpad memory 120. The mapping instruction 204, for instance, specifies a mapping between a virtual memory address 116 used in the execution of software on the processing core 106 with a physical memory address 128 used by the scratchpad memory 120.

The memory management unit 108, upon receipt of the mapping instruction 204, generates a virtual-to-physical mapping entry 206 for inclusion in storage 126, e.g., in SRAM, of the instruction managed TLB 122. In an implementation, the storage 126 is configured as a circular buffer in which the address mappings 124 (e.g., the virtual-to-physical mapping entries) are allocated and deallocated in order, thereby avoiding use of complex allocation logic and improving access efficiency. Other configuration options for the storage 126 are also contemplated. In this way, the mapping instruction source 202 is configured to control which address mappings 124 (e.g., and respective virtual-to-physical mapping entries 206) are maintained in the instruction managed TLB 122. In the previous example, for instance, the mapping instruction source 202 allocates the virtual-to-physical mapping entry 206. Other examples are also contemplated in which the mapping instruction 204 is used to deallocate the virtual-to-physical mapping entry 206.

The mapping instruction 204 is also configurable to support control of coherence behaviors, e.g., for respective virtual-to-physical mapping entries 206. The mapping instruction 204, for instance, in the illustrated example includes a coherence bit 208 that specifies coherence behaviors to be used for data maintained at respective physical memory addresses 128 of the scratchpad memory 120. For example, the coherence bit 208 is configurable to specify a “lazy” write back behavior is to be used, which is also referred to as a “write behind” in which data marked as “dirty” is not written back from scratchpad memory 120 until a replacement is encountered. In another example, the coherence bit 208 is configured to specify an aggressive “write through” behavior in which the data is written back from the scratchpad memory 120 upon receipt of the data at the scratchpad memory 120. Accordingly, in this example the mapping instruction 204 is used to control inclusion of virtual-to-physical mapping entries 206 within the instruction managed TLB 122 and how corresponding data is to be managed in the scratchpad memory 120. The instruction managed TLB 122 is thus configured to control access to the scratchpad memory 120 by a memory instruction based on the virtual-to-physical mapping entries 206, further discussion of which is included in the following example and shown in a corresponding figure.

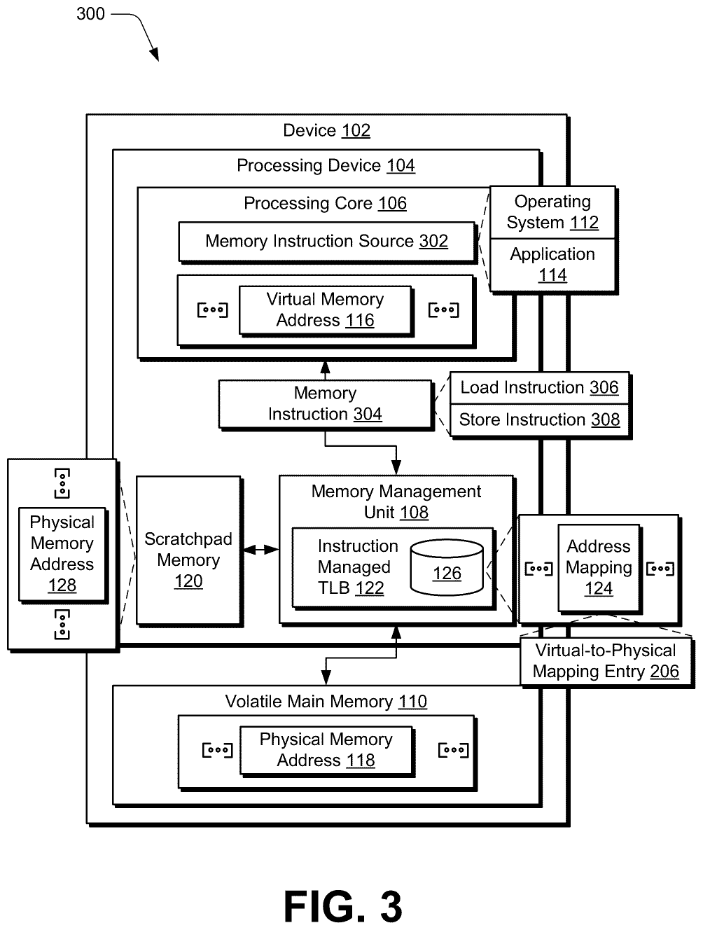

FIG. 3 is a block diagram of a non-limiting example system 300 configured to employ address mappings in an instruction managed translation lookaside buffer of FIG. 2 to implement a memory instruction to a scratchpad memory that is received from a processing core of a processing device. The illustrated example also includes the processing device 104, the processing core 106, the memory management unit 108, and the volatile main memory 110.

The instruction managed TLB 122 includes the virtual-to-physical mapping entry 206 maintained as an address mapping 124 in the storage 126, e.g., a circular buffer, as described in FIG. 2. Accordingly, in this example the virtual-to-physical mapping entry 206 is used to manage interaction of software executed by the processing core 106 with the scratchpad memory 120.

A memory instruction source 302, for instance, is executed by the processing core 106 as software similarly to the mapping instruction source 202 of FIG. 2, e.g., through execution of software such as an operating system 112 and/or application 114.

The memory instruction source 302 issues a memory instruction 304 that specifies a virtual memory address 116. The memory instruction 304, for instance, is configurable as a load instruction 306 that is executed as an operation to load data associated with the virtual memory address 116. In another instance, the memory instruction 304 is configurable as a store instruction 308 to store data associated with the virtual memory address 116.

In order to execute the memory instruction 304, the memory management unit 108 utilizes the virtual-to-physical mapping entry 206 from the instruction managed TLB 122 that was stored as described in relation to FIG. 2. The virtual-to-physical mapping entry 206 is employed to translate the virtual memory address 116 of the memory instruction 304 into a physical memory address 128 of the scratchpad memory 120. Once translated, the memory management unit 108 is configurable to obtain data from the physical memory address 128 (e.g., as a load operation responsive to a load instruction 306) of the scratchpad memory 120 or store data to the physical memory address 128 of the scratchpad memory 120, e.g., as a store operation responsive to a store instruction 308.

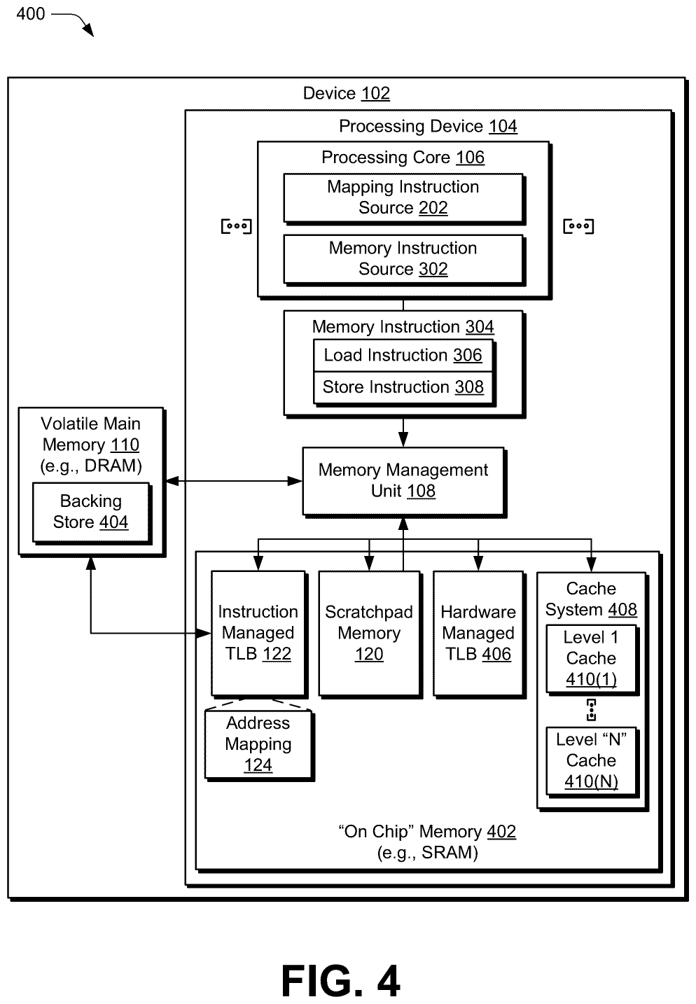

FIG. 4 is a block diagram of a non-limiting example system 400 showing operation of an instruction managed translation lookaside buffer and scratchpad memory in greater detail in conjunction with additional data management memory functionality of a processing device. The processing device 104 includes a processing core 106, memory management unit 108, and an instruction managed TLB 122 as previously described. The volatile main memory 110 is implemented using dynamic random access memory (DRAM) in this example that is “off chip” from the processing device 104. The processing device 104 also includes “on chip” memory 402 that is implemented as part of an integrated circuit of the processing device 104. The “on chip” memory 402 in the illustrated example is used to implement the instruction managed TLB 122 and the scratchpad memory 120, e.g., as a separate SRAM array, dynamic partition of an existing cache SRAM array, and so forth.

The volatile main memory 110 in this example maintains a backing store 404 associated with the instruction managed TLB 122. The backing store 404 is configured to maintain translation tables and corresponding translation entries (e.g., virtual-to-physical mapping entries 206) for respective processes executed by the processing core 106. The backing store 404, therefore, enables the instruction managed TLB 122 to implement context switches between processes executed on a single processing core by swapping translation tables between SRAM of the “on chip” memory 402 implementing the instruction managed TLB 122 and “off chip” DRAM implementing the backing store 404.

The backing store 404, for instance, is configured to maintain translation tables used by the instruction managed TLB 122 for each of the processes executed by the processing core. The translation tables (and corresponding translation entries illustrated as address mapping 124) are then switched in the instruction managed TLB 122 for use by respective processes executed by the processing core 106. For example, the backing store 404 is managed by an operating system 112 to store translation tables. The backing store 404 enables a context switch between processes in order to also switch corresponding translation tables and address mappings 124 between storage in volatile main memory 110 as part of the backing store 404 (e.g., DRAM) that is “off-chip”and “on-chip” memory 402 of the instruction managed TLB 122, e.g., using SRAM. In this way, the instruction managed TLB 122 in conjunction with the scratchpad memory 120 supports use in general purpose scenarios, such as for use in processing general purpose CPU workloads which is not possible in conventional techniques.

By providing a backing store 404 in volatile main memory 110, seamless context switches and the virtualization of scratchpad mappings are supported across processes. Like traditional TLBs such as the hardware managed TLB 406, these mappings can be lazily evicted and written back to volatile main memory 110 allowing for efficient sharing of the instruction managed TLB 122 capacity between processes as desired.

The processing device 104 in this example also includes a hardware managed translation lookaside buffer (illustrated as hardware managed TLB 406) that is configured to implement hardware managed translation of virtual memory address to physical memory addresses. The hardware managed TLB 406 is a specialized cache as implemented in hardware of the “on chip” memory 402 that leverages internal logic to control which address mappings are maintained with the cache, e.g., based on recency.

The “on chip” memory 402 of the processing device 104 is also configured to include a cache system 408 having a plurality of cache levels, examples of which are illustrated as a level 1 cache 410(1), . . . , to a level “N” cache 410(N). The cache system 408 is configured to leverage on-chip storage and coherence infrastructures. The cache system 408, for instance, is configurable to include logic implemented in hardware internally to the cache system 408 as previously described that controls what data is maintained internally within respective cache levels, e.g., based on recency of data use, spatial locality considerations, and so forth. Thus, in the illustrated example the processing device 104 is configured to leverage hardware-based data control that is performed internally by a respective hardware (e.g., hardware managed TLB 406 and cache system 408) as well as instruction based control managed by a mapping instruction source 202 and memory instruction source 302, e.g., the instruction managed TLB 122 and the scratchpad memory 120.

In an implementation, when a process is “switched in” as part of a context switch, active mapping entries in the instruction managed TLB 122 are refilled if not already resident, e.g., register context, by switching address mappings 124 (e.g., virtual-to-physical mapping entries 206) using the backing store 404. Furthermore, processes are restricted in one or more examples from registering active address mappings 124 in the instruction managed TLB 122 that do not fit in the instruction managed TLB 122 and overflow capacity. Explicit backing storage in the backing store 404 is provided for lazy writebacks as part of coherency behaviors as described above. When evicting a translation, “dirty” data in the scratchpad memory 120 associated with that mapping is written back to memory, similar to an explicit “unmap” operation.

The memory management unit 108 is also configured to handle “fills” on context switching, and the operating system 112 provides memory allocations, e.g., for translation table storage in the backing store 404. The mapping instruction source 202 is configurable to add/remove virtual-to-physical mapping entries 206 without operating system 112 intervention. In an implementation, segment-based mappings support use of “x86” memory addressing modes, e.g., to support “pointer chasing” across both scratchpad-mapped virtual addresses and cache hierarchy resident data.

On address translation, in an implementation both the hardware managed TLB 406 and the instruction managed TLB 122 are searched in parallel using segment-based mappings. For addresses that hit in the hardware managed TLB 406, miss in the instruction managed TLB 122, and miss in the level 1 cache 410(1), level 1 miss requests are sent further down the cache hierarchy, e.g., to the level “N” cache 410(N). Addresses that hit in both the instruction managed TLB 122 and the hardware managed TLB 406 are translated by the instruction managed TLB 122 and forwarded to the scratchpad memory 120 for data access. Accesses to virtual addresses mapped via tiled mapping entries using traditional “x86” addressing modes are processed through a cache hierarchy of the cache system 408. As part of this, built in coherence mechanisms of the cache system 408 are leveraged.

In an implementation, dynamic configuration is implemented of an exclusive cache level in the cache system 408, e.g., a level three cache, as a victim cache. A victim cache is an additional cache used to hold blocks of data that have been recently evicted due to a cache replacement policy. The exclusive cache level is configurable to fill victimized lines from a level 2 cache and/or is configured to act as a victim cache exclusively for the scratchpad memory 120. In this way, data structures may be tiled in a two-level manner, bringing tiles of contiguous data to be stored in the exclusive cache level while striding through swizzled strides/tiles of those chunks in a smaller scratchpad memory 120 capacity.

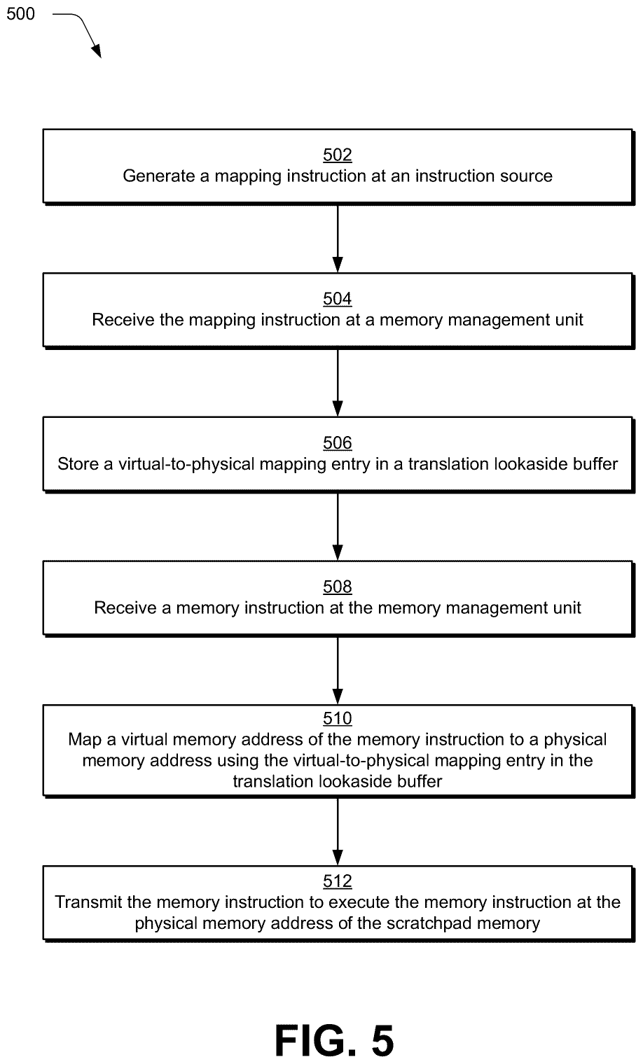

FIG. 5 depicts a procedure 500 in an example implementation of setting a virtual-to-physical mapping entry in an instruction based translation lookaside buffer by execution of a mapping instruction source and translation of a virtual memory address of a memory instruction issued by a memory instruction source to access a physical memory address of a scratchpad memory.

A mapping instruction is generated at an instruction source (block 502). By way of example, a mapping instruction source 202 is executed as software by a processing core 106 of a processing device 104, e.g., as an operating system 112, application 114, and so forth. The mapping instruction source 202 generates the mapping instruction 204 to control which entries are included in the instruction managed TLB 122.

The mapping instruction is then received at a memory management unit (block 504). By way of example, the mapping instruction 204 is received at the memory management unit 108 from the processing core 106. The mapping instruction 204 specifies a mapping of a virtual memory address 116 to a physical memory address 128 of the scratchpad memory 120.

A virtual-to-physical mapping entry is stored in a translation lookaside buffer (block 506). By way of example, the memory management unit 108 generates the virtual-to-physical mapping entry 206 based on the mapping instruction 204, which is stored as part of the instruction managed TLB 122. In this way, the mapping instruction source 202 is configured to specify a virtual-to-physical mapping entry 206 for inclusion in the instruction managed TLB 122. Similar techniques are also usable to remove a virtual-to-physical mapping entry 206 from the instruction managed TLB 122, e.g., through use as a circular buffer by supplying an additional mapping instruction 204 that causes replacement of the virtual-to-physical mapping entry 206.

A memory instruction is received at the memory management unit (block 508). By way of example, the memory instruction 304 is received from the processing core 106 as generated by the memory instruction source 302, which may be the same as or different from the mapping instruction source 202.

A virtual memory address of the memory instruction is mapped to a physical memory address using the virtual-to-physical mapping entry in the translation lookaside buffer (block 510). By way of example, the memory management unit 108 employs the instruction managed TLB 122 to translate the virtual memory address of the memory instruction 304 to locate a corresponding physical memory address 128 of the scratchpad memory 120.

The memory instruction is then transmitted to execute the memory instruction at the physical memory address of the scratchpad memory (block 512). By way of example, the memory instruction 304 is a load instruction 306 and therefore retrieves data from the physical memory address 128, which is communicated back to the memory instruction source 302 of the processing core 106. In another example, the memory instruction 304 is a store instruction 308 which causes data of the memory instruction 304 to be stored at the physical memory address 128 of the scratchpad memory 120. A variety of other examples are also contemplated.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 102) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A device comprising:
a memory management unit to:
receive a mapping instruction from a mapping instruction source, the mapping instruction specifying a mapping between a virtual memory address and a physical memory address of a scratchpad memory; and
store a virtual-to-physical mapping entry in a translation lookaside buffer based on the mapping instruction.

2. The device of claim 1, wherein the mapping instruction specifies a range of said virtual memory addresses that are to be mapped to a respective range of physical memory addresses of the scratchpad memory.

3. The device of claim 1, wherein the mapping instruction specifies a coherence behavior to manage data consistency at the physical memory address of the scratchpad memory.

4. The device of claim 1, further comprising a processing core configured to execute the mapping instruction source to generate the mapping instruction to map the virtual memory address to the physical memory address of the scratchpad memory.

5. The device of claim 4, wherein the processing core, the translation lookaside buffer, the scratchpad memory, and the memory management unit are implemented in hardware of an integrated circuit.

6. The device of claim 4, wherein the mapping instruction source:
is an operating system or application executed by the processing core;
the operating system or application employs the virtual memory address; and
the processing core is configured as part of a central processing unit.

7. The device of claim 1, further comprising a backing store maintained in volatile main memory, the backing store configured to maintain mappings between virtual memory addresses and physical memory addresses of the scratchpad memory.

8. The device of claim 7, wherein the backing store supports context switches of a process executed by a respective processing core.

9. The device of claim 7, wherein the backing store supports virtualization of the mapping across processes executed by respective processing cores of a plurality of processing cores.

10. The device of claim 1, further comprising static random access memory implementing the scratchpad memory to store data at the physical memory address.

11. A system comprising:
a processing core configured to generate a memory instruction to a scratchpad memory, the memory instruction specifying a virtual memory address; and
a memory management unit implemented to:
map the virtual memory address to a physical memory address of the scratchpad memory using a translation lookaside buffer; and
transmit the memory instruction to the physical memory address of the scratchpad memory to execute the memory instruction.

12. The system of claim 11, wherein the memory instruction is:
a load instruction to load data from the physical memory address of the scratchpad memory to the processing core; or
a store instruction to store data from the processing core to the physical memory address of the scratchpad memory.

13. The system of claim 11, wherein:
the processing core is configured to generate a mapping instruction specifying a mapping between the virtual memory address and the physical memory address of the scratchpad memory; and
the memory management unit is configured to store a virtual-to-physical mapping entry in the translation lookaside buffer based on the mapping instruction.

14. The system of claim 11, further comprising a backing store maintained in volatile main memory, the backing store configured to maintain mappings between virtual memory addresses and physical memory addresses of the scratchpad memory.

15. The system of claim 14, wherein the backing store supports context switches of processes executed by a respective processing core.

16. The system of claim 14, wherein the backing store supports virtualization of the mapping across processes executed by respective processing cores of a plurality of processing cores.

17. The system of claim 11, wherein the scratchpad memory is implemented using static random access memory to store data at the physical memory address.

18. A method comprising:
receiving a mapping instruction at a memory management unit, the mapping instruction specifying a mapping of a virtual memory address to a physical memory address of a scratchpad memory;
storing a virtual-to-physical mapping entry in a translation lookaside buffer based on the mapping instruction; and
controlling access, by the memory management unit, of a memory instruction to the physical memory address of the scratchpad memory by translating the virtual memory address received via the memory instruction to the physical memory address of the scratchpad memory based on the stored virtual-to-physical mapping entry in the translation lookaside buffer.

19. The method of claim 18, wherein the mapping instruction specifies a range of said virtual memory addresses that are to be mapped to a respective range of physical memory addresses of the scratchpad memory.

20. The method of claim 18, wherein the mapping instruction specifies a coherence behavior to manage data consistency at the physical memory address of the scratchpad memory.
